(19) United States
(12) Patent Application Publication
(10) Pub. No.: US 2011/0185018 A1
(43) Pub. Date: Jul. 28, 2011

(54) CONTENT DELIVERY SYSTEM, CONTENT DELIVERY METHOD AND COMPUTER PROGRAM

(76) Inventor: TORU Osuga, Tokyo (JP)

(21) Appl. No.: 13/063,853

(22) PCT Filed: Oct. 9, 2009
(86) PCT No.: PCT/JP2009/005294

§ 371 Date: Mar. 14, 2011

(30) Foreign Application Priority Data
Oct. 9, 2008 (JP) 2008-262757

(51) Int. Cl. G06F 15/16

(52) U.S. Cl. 709/203

(57) ABSTRACT

A content delivery device and method is provided to deliver content data from a server to a user terminal in response to a download request of content data input by the user terminal. It implements a first transmission step which retrieves content data, sets a low initial value as a transmission data rate and transmits content data to the user terminal based on a first transport protocol adopting a slow start algorithm gradually increasing the transmission data rate and a second transmission step which retrieves content data and transmits content data to the user terminal based on a second transport protocol adopting a high-speed algorithm setting a higher transmission data rate than the transmission data rate set by the slow start algorithm, wherein the second transmission step is performed to start transmission of content data but the first transmission step is performed after a transmission parameter of the second transmission step reaches a threshold.

### TECHNICAL FIELD

The present invention relates to content delivery systems, content delivery methods and computer programs.

The present application claims priority on Japanese Patent Application No. 2008-262757 filed on Oct. 9, 2008, the content of which is incorporated herein by reference.

### BACKGROUND ART

Owing to a recent trend in the high performance of computers and the high bandwidths of networks, VOD (Video on Demand) services, which allow users to watch high-quality video contents according to user's preference, have become popular.

As video content delivery methods, progressive download delivery procedures adopting the same protocols as conventional. Web contents, i.e. HTTP (Hypertext Transfer Protocol)/TCP (Transmission Control Protocol), as well as streaming delivery procedures using exclusive streaming servers, i.e. RTSP (Real Time Streaming Protocol) and MMS (Microsoft Media Services), have been widely adopted.

The progressive download delivery procedures are referred to as simulated streaming or HTTP streaming, which have various merits providing good facility of system architectures and a low probability of fire walls inhibiting downloading of contents.

Since an interruption of video reproduction causes serious and negative effects on quality of user sensations, video delivery services such as VOD services have absorbed fluctuations of reception data rates via buffers installed in user terminals.

Installing buffers in user terminals may reduce the occurrence of interruption, but it causes a problem that a user's latency for starting reproduction must be increased since reproduction cannot be started without completion of retrieving necessary data (hereinafter, referred to as initial buffer data) prior to the preset reproduction start timing.

As the technology for solving this problem in the streaming delivery procedure, Patent Document 1 (Japanese Patent. Application Publication No. 2006-115477) discloses a content delivery method.

This content delivery method is designed to actually measure an available band during content transmission in progress or estimate behavior of a transmission data rate according to TCP based on various pieces of information such as a delay time and a packet loss ratio, thus calculating a transmission data rate which can maintain fairness with other connections. Thereafter, initial buffer data is received based on the calculated transmission data rate; thus, it is possible to start reproduction upon retrieving initial buffer data as fast as possible.

This content delivery method is used in Fast Streaming of Microsoft (a registered trademark) and TurboPlay of RealNetworks (a registered trademark), for example.

Patent Document 2 (Japanese Patent Application Publication No. 2002-135506) discloses a transmission control method in which, when a counterpart terminal has designated a maximum reception buffer size for facsimile transmission using the Internet, a data transmission of a burst transfer mode is performed at a maximum data transmission speed permissible in the currently-used network (e.g. several hundreds kbps through several Mbps); thus, it is possible to employ a maximally effective information transmission speed.

### PRIOR ART DOCUMENTS

### Patent Documents

Patent Document 1: Japanese Patent Application Publication No. 2006-115477

Patent Document 2: Japanese Patent Application Publication No. 2002-135506

### SUMMARY OF THE INVENTION

### Problems to be Solved by the Invention

However, the above technologies have rooms of improving the following points.

Upon adopting the content delivery method of Patent Document 1 which employs TCP as the transport protocol, the progressive download procedure is unable to prevent an influence due to slow start control of TCP, which in turn prevents high-speed transmission of initial buffer data.

That is, TCP performs transmission at a small transmission data rate just after starting transmission but gradually increases the transmission data rate during a success of transmission, thus preventing congestion of a network. For this reason, it takes a long time to increase the transmission data rate of TCP up to an upper-limit value of the transmission data rate calculated by the content delivery method, thus increasing a user's latency.

The transmission control method of Patent Document 2 has two modes, i.e. a UDP mode and a TCP mode, wherein the UDP mode can be selected to transmit video information in order to prevent the flow control operation including the slow start control of the TCP mode.

Once video information is transmitted upon selecting the UDP mode, this transmission control method is unable to switch over to the TCP mode during transmission in progress even when the UDP mode changes the data transmission speed.

Upon adopting the technology of Patent Document 2, the progressive download procedure of video contents needs to transmit initial buffer data as well as all data included in video contents via the UDP mode; this causes a problem in terms of the reliability of transmission and the quality of video reproduction.

The present invention is made in the aforementioned circumstances, wherein the object thereof is to provide a content delivery system, a content delivery method and a computer program, which can reduce a user's latency for reproduction owing to a high-speed transmission at a high transmission data rate preventing slow start control which is conventionally needed to start transmission of contents.

### Means for Solving the Problems

The present invention provides a content delivery system in which content data is delivered from a server to a user terminal in response to a download request of content data input by the user terminal, specifically a content delivery system including a content data storage unit which stores content data; a first transmission unit which retrieves content data from the content data storage unit, sets a low initial value as a transmission data rate and transmits content data to the user terminal based on a first transport protocol adopting a slow start algorithm gradually increasing the transmission data rate; a second transmission unit which retrieves content data from the content data storage unit and transmits content data to the user terminal based on a second transport protocol adopting a high-speed algorithm setting a higher transmission data rate than the transmission data rate set by the slow start algorithm; and a transmission control unit which allows the second transmission unit to start transmission of content data but which allows the first transmission unit to transmit untransmitted content data after a transmission parameter of the second transmission unit reaches a threshold.

The present invention provides a content delivery method in which content data is delivered from a server to a user terminal in response to a download request of content data input by the user terminal, specifically a content delivery method including a first transmit step which retrieves content data, sets a low initial value as a transmission data rate and transmits content data to the user terminal based on a first transport protocol adopting a slow start algorithm gradually increasing the transmission data rate; and a second transmit step which retrieves content data and transmits content data to the user terminal based on a second transport protocol adopting a high-speed algorithm setting a higher transmission data rate than the transmission data rate set by the slow start algorithm, wherein it is characterized in that the second transmit step is performed to start transmission of content data but the first transmit step is performed to transmit untransmitted content data to the user terminal after a transmission parameter of the second transmit step reaches a threshold.

The present invention provides a computer program which a server executes to deliver content data from a server to a user terminal in response to a download request of content data input by the user terminal, specifically a compute program including a first transmission process which retrieves content data, sets a lower initial value as a transmission data rate and transmits content data to the user terminal based on a first transport protocol adopting a slow start algorithm gradually increasing the transmission data rate, and a second transmission process which retrieves content data and transmits content data to the user terminal based on a second transport protocol adopting a high-speed algorithm setting a higher data transmission rate than the transmission data rate set by the slow start algorithm, wherein it is characterized in that the second transmission process is performed to start transmission of content data but the first transmission process is performed to transmit untransmitted content data to the user terminal after a transmission parameter of the second transmission process reaches a threshold.

This invention is able to prevent slow start control and to start transmission of content data at a high transmission data rate; hence, it is possible to reduce a user's latency for starting reproduction of content data.

In the present invention, constituent elements are not necessarily disposed independently of each other; hence, it is possible to assemble plural constituent elements into a single unit; it is possible to form a single unit constituted of plural units; it is possible to share one constituent element as a part of another constituent element; and alternatively, it is possible to overlap a part of one constituent element with a part of another constituent element.

### Effect of The Invention

The present invention provides a content delivery system, a content delivery method and a computer program, which are able to perform transmission at a higher transmission data rate but to prevent slow start control upon starting transmission of content data, thus reducing a user's latency for starting reproduction of content data.

### BRIEF DESCRIPTION OF THE DRAWINGS

FIG. 1 A constitutional diagram representative of a content delivery system according to an embodiment of the present invention.

FIG. 2 A flowchart representative of a content delivery method according to the embodiment.

### MODE FOR CARRYING OUT THE INVENTION

Hereinafter, an embodiment of the present invention will be described with reference to drawings. In all drawings, the same constituent elements are designated by the same reference numerals; hence, their description will be omitted as necessary.

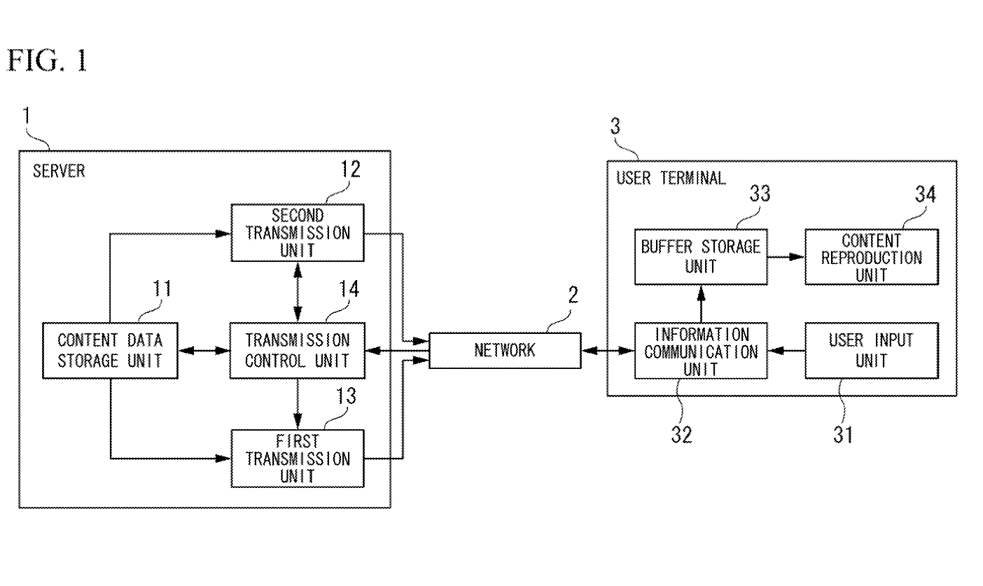

FIG. 1 is a constitutional diagram of a content delivery system according to the embodiment of the present invention.

A content delivery system in which content data is delivered from a server 1 to a user terminal 3 in response to a download request of content data input by the user terminal 3 is constituted of a content data storage unit 11 which stores content data; a first transmission unit 13 which retrieves content data from the contend data storage unit 11, sets a low initial value as a transmission data rate and transmits content data to the user terminal 3 based on a first transport protocol adopting a slow start algorithm gradually increasing the transmission data rate; a second transmission unit 12 which retrieves content data from the content data storage unit 11 and transmits content data to the user terminal 3 based on a second transport protocol adopting a high-speed algorithm setting a higher transmission data rate than the transmission data rate set by the slow start algorithm; and a transmission control unit 14 which allows the second transmission unit 12 to start transmission of content data but allows the first transmission unit 13 to transmit untransmitted content data after a transmission parameter of the second transmission unit 12 reaches a threshold.

In this connection, content data include one of video and audio, or both of them.

The threshold can be determined based on an instruction which is input by a certain content delivery provider or a user of the user terminal 3.

A part of the constitution or the entire constitution of the content delivery system of the present embodiment can be realized using the hardware or using computer programs (or program codes) implemented by processors.

Processors read computer programs from storage media such as nonvolatile memory so as to execute them.

When the functions of the second transmission unit 12, the first transmissions unit 13 and the transmission control unit 14 are realized using computer programs, the server 1 implements those computer programs in order to deliver content data from the server 1 to the user terminal 3 in response to a download request of content data input by the user terminal 3. The computer programs include a first transmission process which retrieves content data, sets a low initial value as a transmission data rate and transmits content data to the user terminal 3 based on a first transport protocol adopting a slow start algorithm gradually increasing the transmission data rate and a second transmission process which retrieves content data and transmits content data to the user terminal based on a second transport protocol adopting a high-speed algorithm setting a higher transmission data rate than the transmission data rate set by the slow start algorithm, wherein the second transmission process is performed to start transmission of content data but the first transmission process is performed to transmit untransmitted content data to the user terminal after a transmission parameter of the second transmission process reaches a threshold.

As a delivery method of content data, the present embodiment adopts a progressive download procedure in which content data is transmitted based on HTTP (Hypertext Transfer Protocol)/TCP (Transmission Control Protocol).

In this case, the server 1 functions as a device serving as a web server or a HTTP server, so that the first transport protocol is set to TCP.

Thus, it is possible to easily implement a system architecture in the present embodiment compared to the conventional system utilizing a streaming-dedicated server and a streaming-dedicated transport protocol.

The network 2 is commensurate with a computer network which is able to connect the server 1 and the user terminal 3, such as the Internet and a LAN.

The user terminal 3 includes a user input unit 31 which inputs a download request upon a user's operation, an information communication unit 32 which transmits the download request to the server 1 and receives content data from the server 1, a buffer storage unit 33 which stores the received content data, and a content reproduction unit 34 which reproduces the stored content dab.

The second transmission unit 12 may have a transmission parameter representing the quantity of content data transmitted by the second transmission unit 12.

The aforementioned threshold is a data quantity which is determined by a certain content delivery provider or user in advance, wherein it is preferable that the threshold be equivalent to the quantity of necessary data (the quantity of initial buffer data) before starting reproduction of contents.

In this case, it is possible to maximally reduce the user's latency for reproduction by way of high-speed delivery of initial buffer data. Remaining content data can be subjected to high-quality delivery via TCP without causing heavy load in other traffics.

In this connection, a certain content delivery provider can uniformly determine the quantity of initial buffer data with respect to all the content data or with respect to individual content data. Alternatively, a certain user can input an arbitrary quantity using the user input unit 31.

A desired reproduction latency, which has been determined by a certain content delivery provider or user in advance, is retrieved and multiplied by a transmission data rate adapted to a transmission path between (the second transmission unit 12 of) the server 1 and the user terminal 3, thus producing a quantity of initial buffer data.

The aforementioned threshold and the quantity of initial buffer data are variable values which can be arbitrarily determined based on an instruction input by a certain content delivery provider or user.

As to the threshold representing a data quantity, it is preferable that a settable range of the threshold embrace a certain data quantity equivalent to the quantity of initial buffer data. Thus, it is possible to identify the threshold with the quantity of initial buffer data.

That is, after the quantity of content data transmitted by the second transmission unit 12 reaches the quantity of initial buffer data, the transmission control unit 14 allows the first transmission unit 13 to transmit untransmitted content data.

When the threshold is identified with the quantity of initial buffer data, the quantity of content data which the first transmission unit 13 retrieves from the content data storage unit 11 is equivalent to a transmitted part of content data precluding initial buffer data or the entire quantity of content data.

Upon retrieving only the transmitted part of content data precluding initial buffer data, the first transmission unit 13 can reduce a. transmission time.

When the first transmission unit 13 retrieves the entire quantity of content data, the user terminal 3 can discard initial buffer data which have been received twice. In addition, it is possible to complement a transmission loss of initial buffer data from the second transmission unit 12 with initial buffer data from the first transmission unit 13.

The content data storage unit 11 may include an area (not shown) storing at least one of the threshold and the reproduction latency. Thus, the second transmission unit 12 is able to read the threshold and the reproduction latency from the content data storage unit 11.

When a transmission source is switched over from the second transmission unit 12 to the first transmission unit 13, the transmission control unit 14 is able to retrieve connection information, which is needed to establish connection between the first transmission unit 13 and the information communication unit 32, from the second transmission unit 12, thus sending it to the first transmission unit 13.

The above connection information may include an IP address of the user terminal 3, a port number of the user terminal 3, a content ID of content data from the second transmission unit 12, a quantity of content data from the second transmission unit 12, and a transmission speed of the second transmission unit 12 in a switchover mode.

As the information representative of the quantity of transmitted content data, it is possible to employ the number of fragments such as packets and chunks included in content data.

As the information representative of a transmission speed of the second transmission unit 12 in a switchover mode, it is possible to employ a congestion window size and a transmission data rate of the second transmission unit 12.

Means of transmitting content data at a higher transmission data rate of the second transmission unit 12 rather than the first transmission unit 13 will be illustrated below.

For instance, the second transport protocol is set to TCP, wherein the second transmission unit 12 may transmit content data with an initial value of a congestion window size of TCP, i.e. a calculated value which is calculated by multiplying a divided value, which is produced by dividing the threshold (i.e. the quantity of initial buffer data) by the preset reproduction latency, by a reciprocating delay time occurring between (the second transmission unit 12 of) the server 1 and the user terminal 3 (i.e. a time counted from the timing, at which a transmission side transmits data, to the timing, at which a receipt confirmation reaches a reception side).

As the round-trip delay time, it is possible to use a round-trip delay time with respect to one of recent communications; it is possible to calculate an average value among round-trip delay times based on the statistics of communications in the past; or it is possible to calculate a minimum value among reciprocating delay times based on the statistics of communications in the past.

The above reproduction latency can be arbitrarily determined by a certain content delivery provider or user.

Alternatively, the second transport protocol is set to TCP, wherein the second transmission unit 12 may transmit content data with an initial value of a congestion window size of TCP, i.e. a calculated value which is produced by multiplying an available frequency range of a link (i.e. a bottleneck link) having the lowest transmission speed among transmission paths between the second transmission unit 12 and the user terminal 13 by a reciprocating delay time between the second transmission unit 12 and the user terminal 13.

The available frequency range of a bottleneck link can be obtained by calculating a difference between reciprocating delay times occurring in consecutively transmitted packets (or packet trains).

The above means refers to a method of setting an initial value of a transmission data rate; hence, when content data is transmitted at a higher transmission data rate of the second transmission unit 12 rather than the first transmission unit 13, it is possible to define variations as follows.

That is, when data transmission is normally performed between the server 1 and the user terminal 3, an increment of a congestion window size of the second transmission unit 12 is larger than an increment of a congestion window size of the first transmission unit 13. When a congestion occurs (or transmitted packets are lost) during data transmission between the server 1 and the user terminal 3, a decrement of the congestion window size of the second transmission unit 12 is lower than a decrement of the congestion window size of the first transmission unit 13.

In the case of TCP serving as the second transport protocol, it is necessary to reload an initial value of the congestion window size of the first transmission unit 13 since the communication status between the server I and the user terminal 3 is initialized due to a switchover from the second transmission unit 12 to the first transmission unit 13.

At this time, the transmission control unit 14 obtains information representing the congestion window size of the second transmission unit 12 at an end-of-transmission, wherein an initial value of the congestion window size of the first transmission unit 13 is identified with the congestion window size of the second transmission unit 12 at an end-of-transmission.

Regardless of the above procedure for taking over the congestion window size, the transmission control unit 14 is able to set an initial value of the congestion window size of the first transmission unit 13 in accordance with the normal slow start control of TCP.

Upon assuming the congestion window size which is used when the first transmission unit 13 transmits content data from its first datagram based on the threshold (i.e. the quantity of initial buffer data), the transmission control unit 14 is able to set the assumed congestion window size as an initial value of the congestion window size of the first transmission unit 13.

When the second transport protocol is set to UDP (User Datagram Protocol), (the second transmission unit 12 of) the server 1 is able to transmit content data at a transmission data rate corresponding to a value which is produced by dividing the threshold (i.e. the quantity of initial buffer data) by the predetermined reproduction latency.

In this connection, a certain content delivery provider or user can arbitrarily determine the reproduction latency.

When the second transport protocol is set to UDP, the second transmission unit 12 is able to transmit content data at a transmission data rate corresponding to an available frequency range of a link having the slowest speed (or a bottleneck link) among transmission paths between (the second transmission unit 12 of) the server 1 and the user terminal 3.

The available frequency range of a bottleneck link can be detected by calculating a difference between reciprocating delay times occurring in a plurality of packets (or packet trains) consecutively transmitted.

When the second transport protocol is set to UDP, the UDP delivery between the second transmission unit 12 and the information communication unit 32 is terminated upon a switchover from the second transmission unit 12 to the first transmission unit 13, so that a process for establishing connection between the first transmission unit 13 and the information communication unit 32 by way of TCP (i.e. rerunning of a communication session) is performed.

Upon establishing connection via TCP, an initial value of the congestion window size needs to be set with respect to the first transmission unit 13.

At this time, the transmission control unit 14 is able to set an initial value of the congestion window size of the first transmission unit 13 in accordance with the normal slow start control of TCP.

Upon assuming the congestion window size which is used when the first transmission unit 13 transmits content data from its first datagram based on the threshold (i.e. the quantity of initial buffer data), the transmission control unit 14 is able to set the assumed congestion window size as an initial value of the congestion window size of the first transmission unit 13.

Upon measuring an available frequency range during transmission of content data or upon assuming the behavior of a transmission data rate according to TCP based on information such as a delay time and a packet loss ratio, the transmission control unit 14 is able to calculate a transmission data rate, which can maintain fairness with other connections, thus setting a value, which is produced by multiplying the calculated transmission data rate by a reciprocating delay time, as an initial value of the congestion window size of the first transmission unit 13.

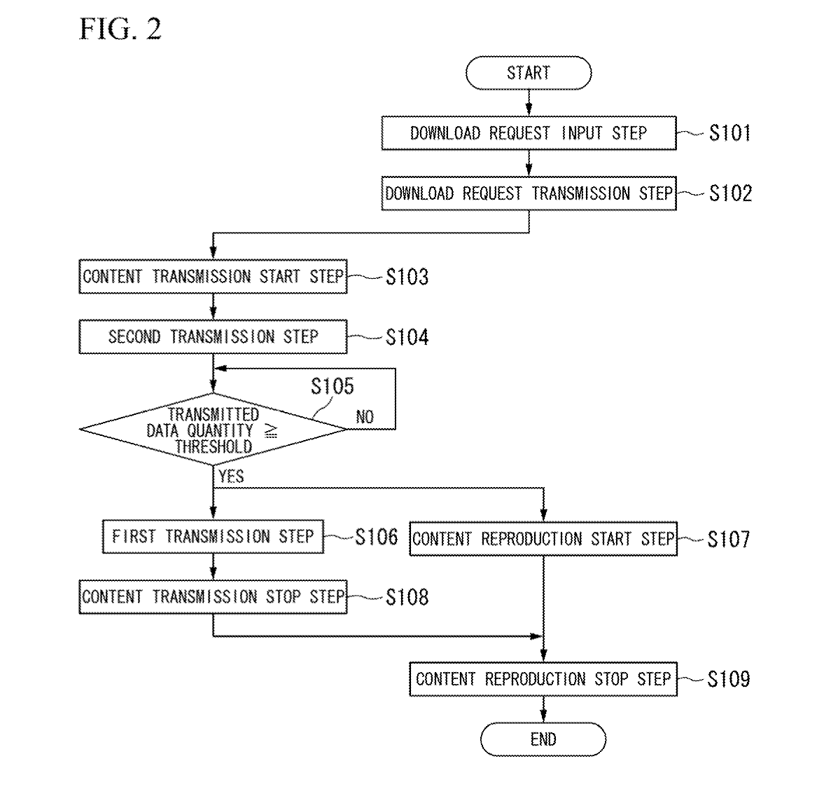

FIG. 2 is a flowchart showing a content delivery method according to the present embodiment.

That is, the content delivery method, in which content data is delivered from the server 1 to the user terminal 3 in response to a download request of content data input by the user terminal 3, includes a first transmission step (step S106) which retrieves content data, sets a low initial value as a transmission data rate and transmits content data to the user terminal 3 based on a first transport protocol adopting a slow start algorithm gradually increasing the transmission data rate, and a second transmission step (step S104) which retrieves content data and transmits content data to the user terminal 3 based on a second transport protocol adopting a high-speed algorithm setting a higher transmission data rate than the transmission data rate set by the slow start algorithm, wherein the second transmission step (step S104) is performed to start transmission of content data but the first transmission step (step S 106) is performed after a transmission parameter of the second transmission step reaches a threshold (i.e. YES of step S105).

The details will be described below.

First, the user input unit 31 inputs a download request upon a user's operation (step S101).

The input download request is transmitted to the transmission control unit 14 of the server 1 via the information communication unit 32 and the network 2 (step S102).

The transmission control unit 14 gives a transmission start instruction of content data designated by the received download request to the second transmission unit 12. When instructed, the second transmission unit 12 establishes connection with the information communication unit 32 (step S103).

Next, the second transmission unit 12 retrieves content data from the content data storage unit 11 so as to transmit content data to the user terminal 3 based on the second transport protocol adopting a high-speed algorithm setting a higher transmission data rate than the transmission data rate set by the slow start algorithm (step S104).

After the transmission parameter reaches the threshold (YES of step S105), the first transmission unit 13 sets a low initial value as the transmission data rate so as to transmit content data to the user terminal 3 based on the first transport protocol adopting the slow start algorithm gradually increasing the transmission data rate (step S106).

The second transmission unit 12 continues transmission of content data until the transmission parameter reaches the threshold (NO of step S105).

In the present embodiment, the transmission parameter corresponds to the quantity of content data subjected to transmission in the foregoing step (step S104) in which the second transmission unit 12 transmits content data to the user terminal 3.

Since the threshold corresponds to the quantity of initial buffer data, the buffer storage unit 33 completes storing initial buffer data therein after the quantity of transmitted data reaches the quantity of initial buffer data (YES of step S105), so that the content reproduction unit 34 which has retrieved content data from the buffer storage unit 33 starts reproduction of content data (step S107).

After transmitting all the content data, the first transmission unit 13 transmits an FIN packet so as to stop transmission of content data (step S108).

Upon receiving the FIN packet, the information communication unit 32 releases connection with the first transmission unit 13. The content reproduction unit 34 is stopped when all the content data stored in the buffer storage unit 33 is reproduced (step S109).

With reference to the drawings, the embodiment of the present invention is described; however, this is an example of the present invention; hence, it is possible to adopt various constitutions other than the foregoing constitution.

For instance, the transmission control unit 14 is able to transmit all the content data to at least one of the first transmission unit 13 and the second transmission unit 12 depending upon the situation of the system.

Depending upon the situation of the system, the transmission control unit 14 allows the first transmission unit 13 to start transmission of content data but allows the second transmission unit 12 to transmit untransmitted content data after the transmission parameter of the first transmission unit 13 reaches the threshold.

When the threshold is set to a data quantity different from the quantity of initial buffer data, the transmission control unit 14 allows the first transmission unit 13 to transmit untransmitted content data after the quantity of content data transmitted by the second transmission unit 12 reaches the data quantity.

When the data quantity is smaller than the quantity of initial buffer data, the user terminal 3 is lowered in a reception data rate (to the normal reception data rate) before starting reproduction of data.

In contrast, when the data quantity is larger than the quantity of initial buffer data, the reception data rate still remains at a high value even when the user terminal 3 starts reproduction; hence, after receiving the predetermined quantity of data, the reception data rate is lowered (to the normal reception data rate).

The transmission parameter of the second transmission unit 12 can be set to the time which elapses after the second transmission unit 12 starts transmission.

Herein, the threshold can be set to the time which is arbitrarily set by a certain content delivery provider or user in advance or identified with the reproduction latency.

In this case, the transmission control unit 14 allows the second transmission unit 12 to start transmission of content data but allows the first transmission unit 13 to transmit untransmitted content data after the time in which the second transmission unit 12 transmits content data reaches the time (or the reproduction latency) which is arbitrarily determined in advance.

Regardless of whether initial buffer data is retrieved, the user terminal 3 is lowered in a reception data rate (to the normal reception data rate) after it comes to the time (or the reproduction latency) which is arbitrarily determined in advance.

In addition, the server 1 may present options such as “high-speed download of (all the) content data”, “high-speed download of initial buffer data alone”, and “no high-speed download”, wherein upon selecting an option by the user terminal 3, the transmission control unit 14 controls the first transmission unit 13 and the second transmission control unit 12 in accordance with a selection of thresholds as follows.
Threshold=infinity (alternatively, either the quantity of content data or the transmission completion time of content data)
Threshold=quantity of initial buffer data
Threshold=0

The content data storage unit 11 can retrieve content data from anywhere; the content data storage unit 11 can retrieve content data from an external content delivery system; or the content data storage unit 11 can retrieve content data from an external storage device.

Regardless of whether the content data storage unit 11 includes an area for storing the threshold and the reproduction latency, it is possible to obtain the threshold and the reproduction latency input by the user input unit 3.

In this case, the threshold and the reproduction latency are transmitted to the transmission control unit 14 along with a download request, so that the second transmission unit 12 obtains the threshold and the reproduction latency via the transmission control unit 14.

### INDUSTRIAL APPLICABILITY

Since the content data are transmitted at a high transmission data rate while preventing the slow start control when starting transmission of content data, the present invention provides a content delivery system, a content delivery method and a computer program, making it possible to reduce the user's reproduction latency before starting reproduction of content data.

### DESCRIPTION OF THE REFERENCE NUMERALS

1 Server

11 Content data storage unit

12 Second transmission unit

13 First transmission unit

14 Transmission control unit

2 Network

3 User terminal

31 User input unit

32 Information communication unit

33 Buffer storage unit

34 Content reproduction unit

1. A content delivery system in which content data are delivered from a server to a user terminal in response to a download request of content data input by the user terminal, said content delivery system comprising:
a content data storage unit which stores content data;
a first transmission unit which retrieves content data from the content data storage unit, sets a low initial value as a transmission data rate and transmits content data to the user terminal based on a first transport protocol adopting a slow start algorithm gradually increasing the transmission data rate;
a second transmission unit which retrieves content data from the content data storage unit and transmits content data to the user terminal based on a second transport protocol adopting a high-speed algorithm setting a higher transmission data rate than the transmission data rate set by the slow start algorithm; and
a transmission control unit which allows the second transmission unit to start transmission of content data but allows the first transmission unit to transmit untransmitted content data after a transmission parameter of the second transmission unit reaches a threshold.

2. The content delivery system according to claim 1, wherein content data are delivered based on HTTP (Hypertext Transfer Protocol)/TCP (Transmission Control Protocol).

3. The content delivery system according to claim 1, wherein the transmission parameter of the second transmission unit corresponds to the quantity of content data transmitted by the second transmission unit.

4. The content delivery system according to claim 3, wherein the second transport protocol corresponds to TCP, and wherein the second transmission unit multiplies a value, which is produced by dividing the threshold by a predetermined reproduction threshold, by a reciprocating delay time occurring between the second transmission unit and the user terminal, thus transmitting content data by use of the calculated value as an initial value of a congestion window size of TCP.

5. The content delivery system according to claim 3, wherein the second transport protocol corresponds to TCP, and wherein the second transmission unit multiplies an available frequency range of a link having the slowest speed among transmission paths between the second transmission unit and the user terminal by a reciprocating delay time occurring between the second transmission unit and the user terminal, thus transmitting content data by use of the calculated value as an initial value of a congestion window size of TCP.

6. The content delivery system according to claim 4, wherein an increment of the congestion window size of the second transmission unit is larger than an increment of the congestion window size of the first transmission unit when data transmission is normally performed between the server and the user terminal, and wherein a decrement of the congestion window size of the second transmission unit is smaller than a decrement of the congestion window size of the first transmission unit when congestion occurs in data transmission between the server and the user terminal.

7. The content delivery system according to claim 5, wherein an increment of the congestion window size of the second transmission unit is larger than an increment of the congestion window size of the first transmission unit when data transmission is normally performed between the server and the user terminal, and wherein a decrement of the congestion window size of the second transmission unit is smaller than a decrement of the congestion window size of the first transmission unit when congestion occurs in data transmission between the server and the user terminal.

8. The content delivery system according to claim 3, wherein the second transport protocol corresponds to UDP (User Datagram Protocol), and wherein the second transmission unit transmits content data at a transmission data rate whose value is calculated by dividing the threshold by a predetermined reproduction latency.

9. The content delivery system according to claim 3, wherein the second transport protocol corresponds to UDP, and wherein the second transmission unit transmits content data at a transmission data rate equivalent to an available frequency range of a link having the slowest speed among transmission paths between the second transmission unit and the user terminal.

10. A content delivery method in which content data are delivered from a server to a user terminal in response to a download request of content data input by the user terminal, said content delivery method comprising:
a first transmission step which retrieves content data, sets a low initial value as a transmission data rate and transmits content data to the user terminal based on a first transport protocol adopting a slow start algorithm gradually increasing the transmission data rate; and
a second transmission step which retrieves content data and transmits content data to the user terminal based on a second transport protocol adopting a high-speed algorithm setting a higher transmission data rate than the transmission data rate set by the slow start algorithm,
wherein the second transmission step is performed to start transmission of content data, but the first transmission step is performed to transmit untransmitted content data to the user terminal after a transmission parameter of the second transmission step reaches a threshold.

11. The content delivery method according to claim 10, wherein content data are delivered based on HTTP (Hypertext Transfer Protocol)/TCP (Transmission Control Protocol).

12. The content delivery method according to claim 10, wherein the transmission parameter of the second transmission step corresponds to the quantity of content data transmitted by the second transmission step.

13. The content delivery method according to claim 12, wherein the second transport protocol corresponds to TCP, and wherein the second transmission step multiplies a value, which is produced by dividing the threshold by a predetermined reproduction threshold, by a reciprocating delay time occurring between the server and the user terminal, thus transmitting content data by use of the calculated value as an initial value of a congestion window size of TCP.

14. The content delivery method according to claim 12, wherein the second transport protocol corresponds to TCP, and wherein the second transmission step multiplies an available frequency range of a link having the slowest speed among transmission paths between the server and the user terminal by a reciprocating delay time occurring between the server and the user terminal, thus transmitting content data by use of the calculated value as an initial value of a congestion window size of TCP.

15. The content delivery method according to claim 13, wherein an increment of the congestion window size of the second transmission step is larger than an increment of the congestion window size of the first transmission step when data transmission is normally performed between the server and the user terminal, and wherein a decrement of the congestion window size of the second transmission step is smaller than a decrement of the congestion window size of the first transmission step when congestion occurs in data transmission between the server and the user terminal.

16. The content delivery method according to claim 14, wherein an increment of the congestion window size of the second transmission step is larger than an increment of the congestion window size of the first transmission step when data transmission is normally performed between the server and the user terminal, and wherein a decrement of the congestion window size of the second transmission step is smaller than a decrement of the congestion window size of the first transmission step when congestion occurs in data transmission between the server and the user terminal.

17. The content delivery method according to claim 12, wherein the second transport protocol corresponds to UDP (User Datagram Protocol), and wherein the second transmission step transmits content data at a transmission data rate whose value is calculated by dividing the threshold by a predetermined reproduction latency.

18. The content delivery method according to claim 12, wherein the second transport protocol corresponds to UDP, and wherein the second transmission step transmits content data at a transmission data rate equivalent to an available frequency range of a link having the slowest speed among transmission paths between the server and the user terminal.

19. A computer program implemented by a server when content data are delivered from the server to a user terminal in response to a download request of content data input by the user terminal, said computer program comprising:
a first transmission process which retrieves content data, sets a low initial value as a transmission data rate and transmits content data to the user terminal based on a first transport protocol adopting a slow start algorithm gradually increasing the transmission data rate; and
a second transmission process which retrieves content data and transmits content data to the user terminal based on a second transport protocol adopting a high-speed algorithm setting a higher transmission data rate than the transmission data rate set by the slow start algorithm,
wherein the second transmission process is performed to start transmission of content data, but the first transmission process is performed to transmit untransmitted content data to the user terminal after a transmission parameter of the second transmission process reaches a threshold.
